(19) United States
(12) Patent Application Publication
(10) Pub. No.: US 2023/0078184 A1
(43) Pub. Date: Mar. 16, 2023

(54) TRANSMISSIONS OF SECURE ACTIVITIES

(71) Applicant: HEWLETT-PACKARD DEVELOPMENT COMPANY, L.P., Spring, TX (US)

(72) Inventors: Xin-Chang CHEN, Taipei City (TW); Chih-Hung CHIEN, Taipei City (TW); Chien-Pai LAI, Taipei City (TW); Chung-Chun CHEN, Taipei City (TW)

(21) Appl. No.: 17/477,290

(22) Filed: Sep. 16, 2021

(51) Int. Cl. H04W 12/03

(52) U.S. Cl. CPC H04W 12/03; H04W 84/12

(57) ABSTRACT

In some examples an electronic device includes a first wireless transceiver, a second wireless transceiver, and a processor. The processor is to transmit data via the first wireless transceiver, detect an indicator of a secure activity, and, in response to a detection of the indicator, stop transmission of the data via the first wireless transceiver and begin transmission of data of the secure activity via the second wireless transceiver.

### BACKGROUND

Electronic devices such as desktops, laptops, notebooks, tablets, and smartphones include wireless transceivers that enable users to connect to wireless networks to perform activities over the wireless networks. The wireless networks include wireless local area networks (WLANs) (e.g., a Wi-Fi network), cellular networks (e.g., 4G, 5G), or a combination thereof. The activities include online shopping, social networking, remote networking, etc.

### BRIEF DESCRIPTION OF THE DRAWINGS

Various examples are described below referring to the following figures.

FIG. 1 is a flow diagram depicting a method for an electronic device to control transmissions of secure activities, in accordance with various examples.

FIG. 2 is an example of a system having controlled transmissions of secure activities, in accordance with various examples.

FIG. 3 is a schematic diagram depicting an electronic device for controlling transmissions of secure activities, in accordance with various examples.

FIG. 4 is a schematic diagram depicting a system having controlled transmissions of secure activities, in accordance with various examples.

FIG. 5 is a flow diagram depicting a method for an electronic device to control transmissions of secure activities, in accordance with various examples.

FIG. 6 is a schematic diagram depicting an electronic device for controlling transmissions of secure activities, in accordance with various examples.

FIG. 7 is a schematic diagram depicting an electronic device for controlling transmissions of secure activities, in accordance with various examples.

### DETAILED DESCRIPTION

As described above, electronic devices such as desktops, laptops, notebooks, tablets, and smartphones include wireless transceivers that enable users to connect to wireless networks (e.g., a wireless area network (WLAN), cellular network) to perform activities such as online shopping, social networking, remote networking, etc. In some instances, the user transmits confidential data (e.g., username, password) to access a website or a remote network to perform an activity. To perform the activity, the user transmits non-confidential data (e.g., a search term, a comment, an item selection) to the website or the remote network, in some instances. Depending upon a type of the wireless network utilized for the transmissions, the transmissions are susceptible to security breaches. A security breach, as used herein, is a misappropriation of confidential data by a third party. For instance, WLANs are more susceptible to security breaches than cellular networks. A user selects a third-party Service Set Identifier (SSID) that is easily mistaken for the SSID of a trusted WLAN network, for instance, or a third-party intercepts a signal of the WLAN. When the confidential data is transmitted, the third party receives the transmission.

This description describes examples of an electronic device to transmit data of a secure activity via a second wireless transceiver that is more secure than a first wireless transceiver. The secure activity, as used herein, is a task that utilizes confidential data. The secure activity includes logging into a website or a remote network or purchasing items from the website or the remote network. In some examples, the electronic device monitors network availability to determine whether a first type of network and a second type of network are available via the first wireless transceiver and the second wireless transceiver, respectively. For example, the first type of network is a WLAN and the second type of network is a cellular network. Responsive to a determination that the first type of network and the second type of network are available, the electronic device monitors for an indicator of the secure activity. Responsive to a detection of the indicator, the electronic device causes the second wireless transceiver to transmit the data of the secure activity. In some examples, responsive to a completion of transmission of the data of the secure activity, the electronic device causes the first wireless transceiver to transmit data of a non-secure activity. The non-secure activity, as used herein, is a task that utilizes non-confidential data. The non-secure activity includes searching the website, entering a comment on the website, working remotely, etc.

By causing the second wireless transceiver that is more secure than the first wireless transceiver to transmit data for secure activities, the electronic device enhances a security of the secure activities. By causing the first wireless transceiver to transmit data for non-secure activities, the electronic device reduces a cost of and enhances a performance for non-confidential data transmissions of the non-secure activities.

In some examples in accordance with the present description, an electronic device is provided. The electronic device includes a first wireless transceiver, a second wireless transceiver, and a processor. The processor is to transmit data via the first wireless transceiver, detect an indicator of a secure activity, and, in response to a detection of the indicator, stop transmission of the data via the first wireless transceiver and begin transmission of data of the secure activity via the second wireless transceiver.

In other examples in accordance with the present description, an electronic device is provided. The electronic device includes a first type of wireless transceiver, a second type of wireless transceiver, and a processor. The processor is to detect an indicator of a secure activity, the indicator received via the first type of wireless transceiver, and, in response to a detection of the indicator, cause transmission of data of the secure activity via the second type of wireless transceiver.

In yet other examples in accordance with the present description, a non-transitory machine-readable medium storing machine-readable instructions is provided. The machine-readable instructions, when executed by a processor, cause the processor to monitor for a transmission. In response to a detection of the transmission, the machine-readable instructions, when executed by a processor, cause the processor to determine a type of the transmission. In response to a determination that the type of the transmission is indicative of a non-secure activity, the machine-readable instructions, when executed by a processor, cause the processor to cause a first wireless transceiver to transmit data of the non-secure activity. In response to a determination that the type of the transmission is indicative of a secure activity, the machine-readable instructions, when executed by a processor, cause the processor to cause a second wireless transceiver to transmit data of the secure activity.

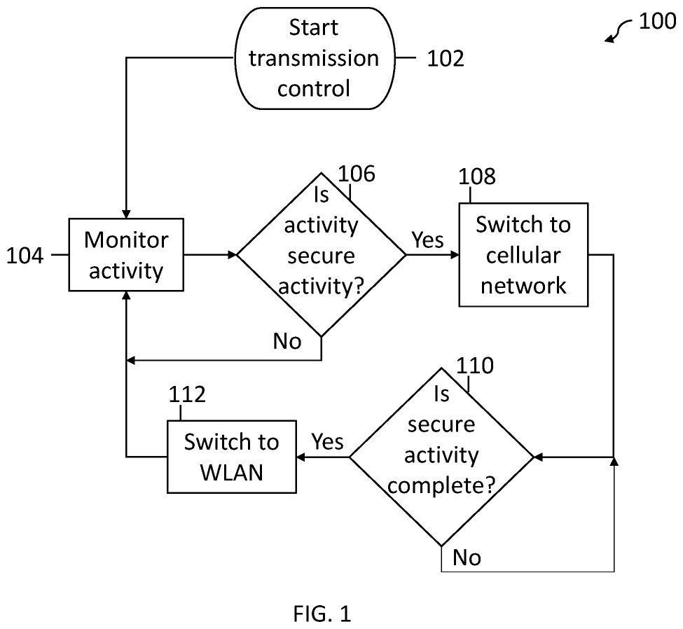

Referring now to FIG. 1, a flow diagram depicting a method 100 for an electronic device to control transmissions of secure activities is provided, in accordance with various examples. The method 100 includes a start point 102 during which the electronic device starts transmission control. During a monitor process 104 of the method 100, the electronic device monitors for an activity. Responsive to detecting the activity, at a decision point 106 of the method 100, the electronic device determines whether the activity is a secure activity. The method 100 includes the electronic device returning to the monitor process 104 responsive to a determination that the activity is a non-secure activity. Responsive to a determination that the activity is a secure activity, the method 100 includes switching transmissions from a WLAN to a cellular network during a switch process 108. At a decision point 110 of the method 100, the electronic device determines whether the secure activity is complete. The method 100 includes the electronic device returning to the decision point 110 responsive to a determination that the secure activity is not complete. Responsive to a determination that the secure activity is complete, the electronic device switches transmissions from the cellular network to the WLAN during a switch process 112. The electronic device returns to the monitor process 104 to monitor for another activity.

In some examples, at the start point 102, the electronic device transmits data via the WLAN. In various examples, to monitor for an activity during the monitor process 104, the electronic device executes an executable code that monitors other executable code of the electronic device. The other executable code includes an operating system (OS) of the electronic device, applications that execute on the electronic device (e.g., desktop applications), applications that execute on or in a browser (e.g., web-based applications), or a combination thereof. The executable code that monitors the other executable code monitors for a keyword that indicates a secure activity, for a selection that indicates the secure activity, or a combination thereof. In some examples, the keywords include “sign in,” “login,” “buy now,” “purchase,” variations thereof, or other words indicative of solicitation by the other executable code of confidential data. The selection includes a user selecting, via a graphical user interface (GUI), an interactive button that indicates a logging in process, a purchasing process, or variations thereof. Responsive to detecting a keyword, a selection, or a combination thereof, the electronic device transmits data of the secure activity via the cellular network.

As described herein, the terms “applications,” “software,” and “firmware” are considered to be interchangeable in the context of the examples provided. “Firmware” is considered to be machine-readable instructions that a processor of the electronic device executes prior to execution of the OS of the electronic device, with a small portion that continues after the OS bootloader executes (e.g., a callback procedure). “Applications” and “software” are considered broader terms than “firmware,” and refer to machine-readable instructions that execute after the OS bootloader starts, through OS runtime, and until the electronic device shuts down. “Application,” “software,” and “firmware,” as used herein, are referred to as executable code.

To determine whether the secure activity is complete during the decision point 110, the electronic device monitors for another keyword, another selection, or a combination thereof that indicates the secure activity is complete. The another keyword includes “sign out,” “log out,” “purchase complete,” “receipt,” or variations thereof. The another selection includes the user selecting, via the GUI, an interactive button that indicates a logging out process, a submission process, or a combination thereof. Responsive to detecting the another keyword, the electronic device transmit subsequent data of non-secure activities via the WLAN.

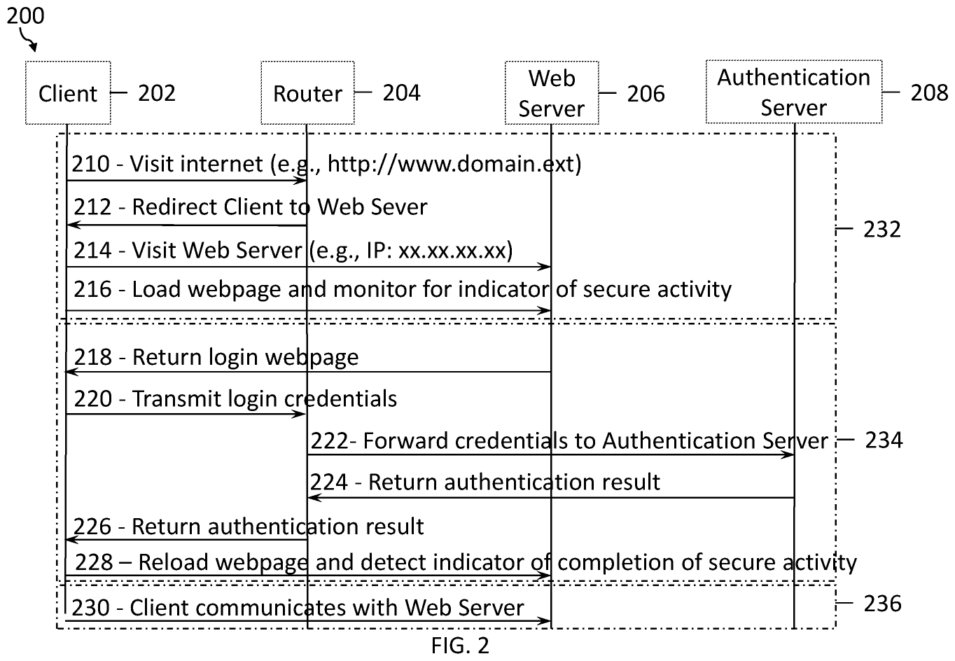

Referring now to FIG. 2, an example of a system 200 having controlled transmissions of secure activities is provided, in accordance with various examples. The system 200 includes a client 202, a router 204, a web server 206, and an authentication server 208. The client 202 is a desktop, a laptop, a notebook, a tablet, a smartphone or any suitable electronic device that includes wireless transceivers. The router 204 is a networking device that forwards data packets between electronic devices coupled to the router. The web server 206 is an electronic device that stores, processes, and delivers web pages to other electronic devices. The web server 206 is identified by an Internet Protocol (IP) address. The authentication server 208 is an electronic device that verifies credentials of a user attempting to access an application.

In various examples, data is routed through the system 200. Responsive to a user visiting an internet website (e.g., http://www.domain.ext), the client 202 transmits data to the router 204 (210). The router 204 redirects the client 202 to the web server 206 (212). The client 202 communicates with the web server 206 (e.g., IP:xx.xx.xx.xx) (214). The client 202 loads a webpage of the website and monitors for an indicator of a secure activity (216). The web server 206 transmits data for a login web page to the client 202 (218). The client 202 transmits login credentials to the router 204 (220). The router 204 forwards the login credentials to the authentication server 208 (222). The authentication server 208 returns an authentication result to the router 204 (224). The router 204 routes the authentication result to the client 202 (226). The client 202 reloads the web page and detects another indicator that indicates completion of the secure activity (228). The client 202 communicates with the web server 206 (230).

In some examples, during a block 232 the client 202 monitors for an indicator of a secure activity, determines that an indicator for visiting the internet website indicates a non-secure activity, and transmits data via a first wireless transceiver (210). The client 202 monitors for an indicator of another secure activity (216). During a block 234, responsive to the client 202 detecting an indicator indicating that the webpage received from the web server 206 is a login page for the internet website (218), the client 202 determines that the login is a secure activity and transmits the login credentials via a second wireless transceiver (220). The client 202 monitors transmissions during the block 234 to detect an indicator indicating that the secure activity is complete (e.g., the authentication result) (226) and transmits subsequent data via the first wireless transceiver during a block 236.

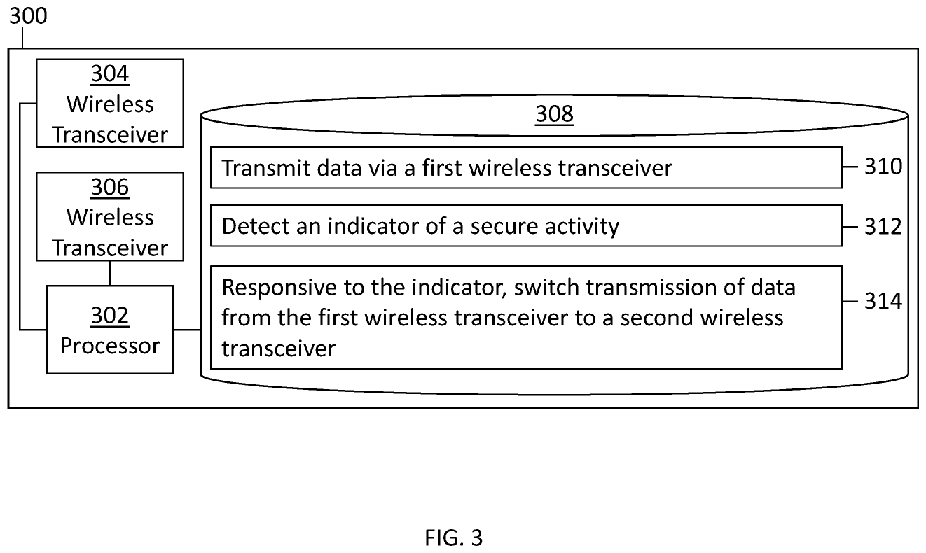

Referring now to FIG. 3, a schematic diagram depicting an electronic device 300 for controlling transmissions of secure activities is provided, in accordance with various examples. The electronic device 300 is the client 202, for example. The electronic device 300 includes a processor 302, wireless transceivers 304, 306, and a storage device 308. The processor 302 is a microprocessor, a microcomputer, a microcontroller, a programmable integrated circuit, a programmable gate array, or other suitable device for managing operations of the electronic device 300. The wireless transceivers 304, 306 are any suitable device for facilitating communication between the electronic device 300 and other electronic devices (e.g., the router 204, the web server 206, the authentication server 208) via a network. The storage device 308 is a hard drive, a solid-state drive (SSD), flash memory, random access memory (RAM), or other suitable memory device for storing data and executable code of the electronic device 300, for example.

While not explicitly shown, the electronic device 300 includes video adapters, sound cards, local buses, input/output devices (e.g., a keyboard, a mouse, a touchpad, a speaker, a microphone, a display device), connectors, or a combination thereof.

In various examples, the processor 302 couples to the wireless transceivers 304, 306 and the storage device 308. The storage device 308 stores machine-readable instructions, which, when executed by the processor 302, cause the processor 302 to perform some or all of the actions attributed to the processor 302. The machine-readable instructions are the machine-readable instructions 310, 312, 314.

In some examples, the machine-readable instructions 310, 312, 314, when executed by the processor 302, cause the processor 302 to control transmissions of secure activities. The machine-readable instruction 310, when executed by the processor 302, causes the processor 302 to transmit data via a first wireless transceiver (e.g., the wireless transceiver 304). The machine-readable instruction 312, when executed by the processor 302, causes the processor 302 to detect an indicator of a secure activity. Responsive to a detection of the indicator, the machine-readable instruction 314, when executed by the processor 302, causes the processor 302 to switch transmission of data from the first wireless transceiver to the second wireless transceiver (e.g., the wireless transceiver 306). To switch transmission of data from the first wireless transceiver to the second wireless transceiver, the processor 302 is to cause the first wireless transceiver to stop transmitting and cause the second wireless transceiver to transmit data of the secure activity, for example.

In various examples, another machine-readable instruction (not explicitly shown), when executed by the processor 302, causes the processor 302 to monitor for another indicator that indicates the secure activity is complete. Responsive to a detection of the another indicator, yet another machine-readable instruction (not explicitly shown), when executed by the processor 302, causes the processor 302 to stop transmission of the data via the second wireless transceiver and continue transmission of data via the first wireless transceiver.

As described above, the second wireless transceiver is more secure than the first wireless transceiver. For example, the wireless transceiver 304 facilitates communication via a WLAN, and the wireless transceiver 306 facilitates communication via a cellular network (e.g., 4G, 5G). The machine-readable instruction 310, when executed by the processor 302, causes the processor 302 to transmit data to cause the wireless transceiver 304 to transmit data via the WLAN. The machine-readable instruction 312, when executed by the processor 302, causes the processor 302 to detect an indicator of a secure activity. As described above with respect to FIG. 1, the processor 302 detects the indicator of the secure activity by executing an executable code that monitors for a keyword, a selection, or a combination thereof. Responsive to a detection of the indicator, the machine-readable instruction 314, when executed by the processor 302, causes the processor 302 to cause the wireless transceiver 306 to transmit data via the cellular network. In some examples, the processor 302 monitors for another indicator that indicates the secure activity is complete. Responsive to a detection of the another indicator, the processor 302 causes the wireless transceiver 304 to transmit data via the WLAN.

By causing the wireless transceiver 306 that is more secure than the wireless transceiver 304 to transmit data for secure activities via the cellular network, the processor 302 enhances a security of the secure activities. By causing the wireless transceiver 304 to transmit data for non-secure activities via the WLAN, the processor 302 reduces a cost of and enhances a performance for non-confidential data transmissions of the non-secure activities.

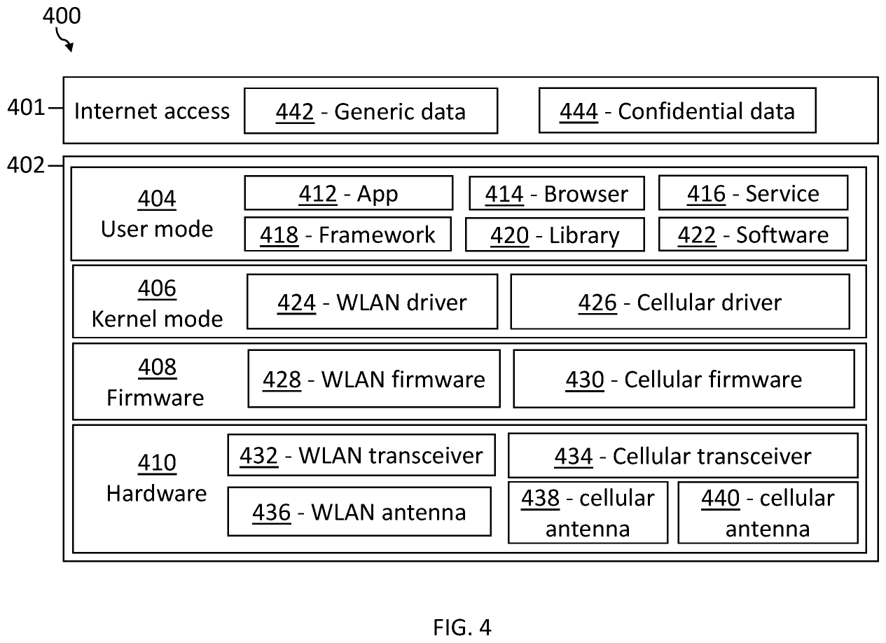

Referring now to FIG. 4, a schematic diagram depicting a system 400 for controlling transmissions of secure activities is provided, in accordance with various examples. The system 400 includes electronic devices 401, 402. The electronic device 401 is any suitable device for enabling access to the internet. The electronic device 401 is the web server 206, for example. The electronic device 401 receives data transmitted by the electronic device 402. As described above, the data includes confidential data 444 of secure activities and generic data 442 of non-secure activities. The electronic device 402 is an electronic device capable of accessing the internet. For example, the electronic device 402 is the client 202 or the electronic device 300. The electronic device 402 includes a user mode level 404, a kernel mode level 406, a firmware level 408, and a hardware level 410.

The user mode level 404 includes an application 412, a browser 414, a service 416, a framework 418, a library 420, and a software 422. The application 412, the browser 414, the service 416, the framework 418, the library 420, and the software 422 are implemented using executable codes of the electronic device. For example, as described above with respect to FIG. 1, the user mode level is executable code that a processor (not explicitly shown) monitors for an indicator of a secure activity. The application 412 is a desktop application, the browser 414 is an application that enables access to the internet, and the service 416 is an application for maintaining a health of the electronic device 402, for instance. Framework 418, the library 420, and the software 422 are applications that enable communication between the executable codes and the kernel mode level 406.

The kernel mode level 406 includes a WLAN driver 424 and a cellular driver 426. The WLAN driver 424 and the cellular driver 426 are executable codes that enable executable codes of the user mode level 404 to communicate with respective components of the hardware level 410. The firmware level 408 includes a WLAN firmware 428 and a cellular firmware 430. The firmware level 408 facilitates communication between the kernel mode level 406 and the hardware level 410. The WLAN firmware 428 and the cellular firmware 430 are executable codes that enable operations of respective components of the hardware level 410. The hardware level 410 includes a WLAN transceiver 432, a cellular transceiver 434, a WLAN antenna 436, cellular antennas 438, 440. The WLAN transceiver 432 is the wireless transceiver 304, and the cellular transceiver 434 is the wireless transceiver 306, for example. A cellular antenna 438 may enable access to a first band of frequency for a cellular network, and a cellular antenna 440 may enable access to a second band of frequency of the cellular network. The WLAN firmware 428 enables operations of the WLAN transceiver 432 and the WLAN antenna 436, for example. The cellular firmware 430 enables operations of the cellular transceiver 434, and the cellular antennas 438, 440, for example.

The electronic device 402 comprises a Basic Input/Output System (BIOS) (not explicitly shown). As used herein, a BIOS refers to hardware or hardware and machine-readable instructions to initialize, control, or operate a computing device (e.g., the electronic device 402) prior to execution of an operating system (OS) of the computing device. Machine-readable instructions included within the BIOS are software, firmware, microcode, or other programming that defines or controls functionality or operation of the BIOS. In some examples, the BIOS is implemented using machine-readable instructions, such as platform firmware of the computing device, executable by the processor. The BIOS operates or executes prior to the execution of the OS of the computing device. The BIOS initializes, controls, or operates components such as hardware components of the computing device and loads or boots the OS of the computing device.

In some examples, the BIOS provides or establishes an interface between hardware devices (e.g., the hardware level 410) or platform firmware (e.g., the firmware level 408) of the computing device and the OS of the computing device, via which the OS of the computing device controls or operates the hardware devices or the platform firmware of the computing device. In some examples, the BIOS implements the Unified Extensible Firmware Interface (UEFI) specification or another specification or standard for initializing, controlling, or operating a computing device.

In various examples, the BIOS includes executable code usable to perform a power on self-test (POST), which includes hardware initialization, testing, and configuration during the boot-up process. The BIOS further includes executable code usable to launch a bootloader from a Master Boot Record (MBR), and to use the bootloader to launch the OS. After launching the OS, the BIOS is usable to provide OS runtime services (e.g., communication with peripheral devices) for the OS and applications. In other examples, UEFI BIOS is used in lieu of the BIOS. Like BIOS, UEFI BIOS includes executable code usable to perform hardware initialization, testing, and configuration during the boot-up process, to launch the OS, and to provide OS runtime services for the OS and applications. However, UEFI BIOS employs globally unique identifier (GUID) partition tables (GPTs) in lieu of MBRs. For the sake of convenience and brevity, this description uses the term BIOS generally to refer to both BIOS and UEFI BIOS. The OS comprises executable code that manages both hardware and executable code (e.g., applications) after a computer has booted up.

In various examples, during a boot-up operation of the electronic device 402, the executable code that monitors other executable code of the electronic device for the indicator of the secure activity registers a network connectivity status indicator (NCSI) network indication callback procedure. As described above, the callback procedure is a small portion of executable code that continues after the OS bootloader executes. The processor monitors a wireless dual-radio to determine whether a WiFi® network and a cellular network are available. The wireless dual-radio includes the WLAN transceiver 432, the cellular transceiver 434, the WLAN antenna 436, and the cellular antennas 438, 440, for example. Responsive to a determination that the WiFi® network and the cellular network are available, the processor enables the executable code that monitors other executable code and an adaptive cellular switching setting. While 4G and 5G cellular networks are described herein, the teachings are applicable to other generations of cellular technology not yet developed but which share characteristics with 4G/5G.

As described above, the processor monitors for an indicator of a secure activity. In some examples, to monitor the browser 414, the processor monitors a user interface of the browser 414. The processor determines a web page that the user is browsing via the browser 414. The processor searches a source code of the web page to search for the indicator of the secure activity. The source code, as used herein, is the language utilized to develop the web page. The source code is a programming language that generates executable code. Source code of the browser 414 includes Hypertext Markup Language (HTML), JavaScript®, or a combination thereof, for example. Responsive to a detection of the indicator, the processor communicates with a network connection manager of the OS to switch off the WLAN transceiver 432 and cause the cellular transceiver 434 to transmit the confidential data 444 of the secure activity. The processor monitors the browser 414 for another indicator that the secure activity is complete. Responsive to a detection of the another indicator, the processor communicates with the network connection manager of the OS to switch on the WLAN transceiver 432 and cause the WLAN transceiver 432 to transmit generic data 442.

In other examples, to monitor the application 412, the processor monitors a user interface of the application 412. As described above, the processor monitors for an indicator that is a selection, via a graphical user interface (GUI) of the application 412, of an interactive button that indicates a logging in process, a purchasing process, or variations thereof. Responsive to a detection of the indicator, the processor communicates with a network connection manager of the OS to switch off the WLAN transceiver 432 and cause the cellular transceiver 434 to transmit confidential data 444 of the secure activity. The processor monitors the application 412 for another indicator that the secure activity is complete. Responsive to a detection of the another indicator, the processor communicates with the network connection manager of the OS to switch on the WLAN transceiver 432 and cause the WLAN transceiver 432 to transmit generic data 442.

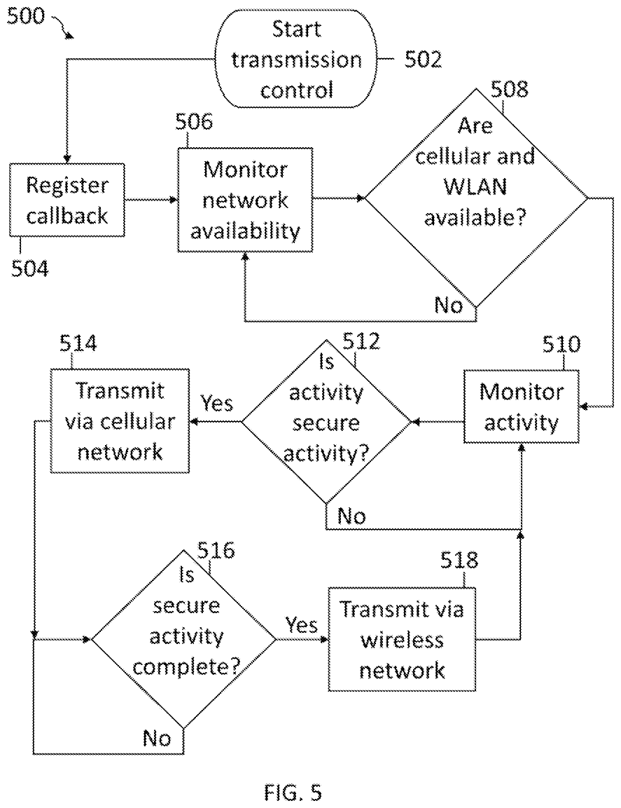

Referring now to FIG. 5, a flow diagram depicting a method 500 for an electronic device (e.g., the client 202, the electronic device 300, 402) to control transmissions of secure activities is provided, in accordance with various examples. The method 500 includes a start point 502 during which the electronic device starts transmission control. The electronic device registers a callback procedure during a register process 504 of the method 500. During a monitor process 506 of the method 500, the electronic device monitors for network availability. At a decision point 508 of the method 500, the electronic device determines whether a cellular network and a WLAN are available. The method 500 includes the electronic device returning to the monitor process 506 responsive to a determination that the cellular network, the WLAN, or a combination thereof is not available. Responsive to a determination that the cellular network and the WLAN area available, the electronic device monitors for an activity during a monitor process 510 of the method 500. Responsive to a detection of the activity, at a decision point 512 of the method 500, the electronic device determines whether the activity is a secure activity. The method 500 includes the electronic device returning to the monitor process 510 responsive to a determination that the activity is a non-secure activity. Responsive to a determination that the activity is a secure activity, the method 500 includes the electronic device transmitting data via the cellular network during a transmit process 514. At a decision point 516 of the method 500, the electronic device determines whether the secure activity is complete. The method 500 includes the electronic device returning to the decision point 516 responsive to a determination that the secure activity is not complete. Responsive to a determination that the secure activity is complete, the electronic device transmits data via the WLAN during a transmit process 518. The electronic device returns to the monitor process 510 to monitor for another activity.

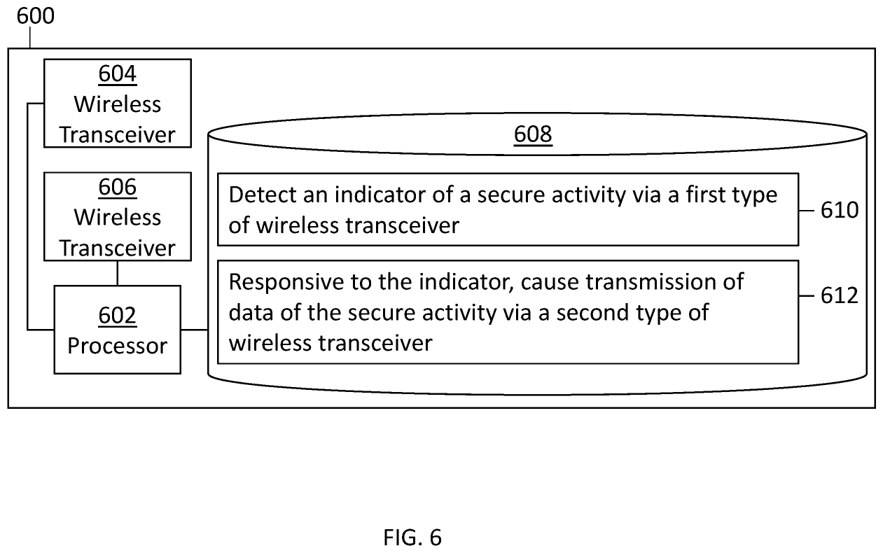

Referring now to FIG. 6, a schematic diagram depicting an electronic device 600 for controlling transmissions of secure activities is provided, in accordance with various examples. The electronic device 600 is the client 202 or the electronic device 300, 402, for example. The electronic device 600 includes a processor 602, a wireless transceiver 604, 606, and a storage device 608. The processor 602 is the processor 302, for example. The wireless transceiver 604, 606 are the wireless transceiver 304, 306, respectively, for example. The storage device 608 is the storage device 308, for example.

In various examples, the processor 602 couples to the wireless transceiver 604, 606 and the storage device 608. The storage device 608 stores machine-readable instructions, which, when executed by the processor 602, cause the processor 602 to perform some or all of the actions attributed to the processor 602. The machine-readable instructions are the machine-readable instructions 610, 612.

In some examples, the machine-readable instructions 610, 612, when executed by the processor 602, cause the processor 602 to control transmissions of secure activities. The machine-readable instruction 610, when executed by the processor 602, causes the processor 602 to detect an indicator of a secure activity via a first type of wireless transceiver (e.g., the wireless transceiver 604). Responsive to a detection of the indicator, the machine-readable instruction 612, when executed by the processor 602, causes the processor 602 to cause transmission of data of the secure activity via a second type of wireless transceiver (e.g., the wireless transceiver 606).

In various examples, another machine-readable instruction (not explicitly shown), when executed by the processor 602, causes the processor 602 to monitor for another indicator that indicates the secure activity is complete. Responsive to a detection of the another indicator, yet another machine-readable instruction (not explicitly shown), when executed by the processor 602, causes the processor 602 to cause transmission of data of a non-secure activity via the second type of wireless transceiver.

As described above, the second type of wireless transceiver is more secure than the first type of wireless transceiver. For example, as described above with respect to FIG. 4, the wireless transceiver 604 facilitates communication via a Wi-Fi network, and the wireless transceiver 606 facilitates communication via a cellular network. The machine-readable instruction 610, when executed by the processor 602, causes the processor 602 to detect the indicator of the secure activity utilizing the executable code that monitors other executable code of the electronic device 600 for the indicator of the secure activity, as described above with respect to FIG. 4. The machine-readable instruction 612, when executed by the processor 602, causes the processor 602 to cause the wireless transceiver 606 to transmit the data of the secure activity (e.g., the confidential data 444) via the cellular network. In some examples, the processor 602 monitors for another indicator that indicates the secure activity is complete. Responsive to a detection of the another indicator, the processor 602 causes the wireless transceiver 604 to transmit data of the non-secure activity (e.g., the generic data 442) via the Wi-Fi network.

In various examples, as described above with respect to FIG. 4, the processor 602 monitors a browser (e.g., the browser 414) for an indicator of the secure activity. For example, the processor 602 receives a login webpage from a web server (e.g., the web server 206) via the Wi-Fi network. The processor 602 searches text of the login webpage to detect the indicator. Responsive to a detection of the indicator, the processor 602 causes the wireless transceiver 604 to switch off and causes the wireless transceiver 606 to transmit the data of the secure activity. The processor 602 monitors the browser for another indicator that the secure activity is complete. The processor 602 receives the another indicator via the cellular network. Responsive to a detection of the another indicator, the processor 602 causes the wireless transceiver 604 to switch on and the wireless transceiver 604 to transmit data.

In some examples, as described above with respect to FIG. 5, the processor 602 monitors network availability to determine whether a first type of network is available via the wireless transceiver 604 and a second type of network is available via the wireless transceiver 606. Responsive to a determination that the first type of network and the second type of network are available, the processor 602 monitors for the indicator of the secure activity.

By causing the wireless transceiver 606 that is more secure than the wireless transceiver 604 to transmit data for secure activities via the cellular network, the processor 602 enhances a security of the secure activities. By causing the wireless transceiver 604 to transmit data for non-secure activities via the WLAN, the processor 602 reduces a cost of and enhances a performance for non-confidential data transmissions of the non-secure activities.

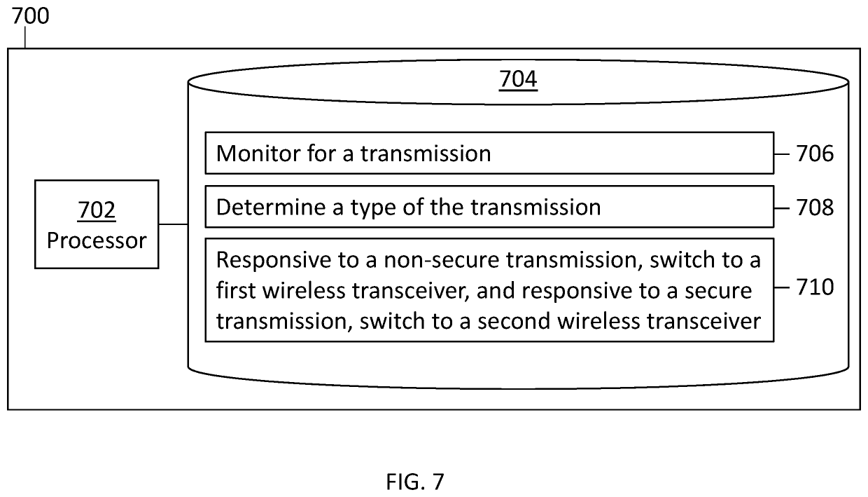

Referring now to FIG. 7, a schematic diagram depicting an electronic device 700 to control transmissions of secure activities is provided, in accordance with various examples. The electronic device 700 is the client 202 or the electronic device 300, 402, 600, for example. The electronic device 700 includes a processor 702 and a non-transitory machine-readable medium 704. The non-transitory machine-readable medium 704 is the storage device 308, 608, for example. The term “non-transitory” does not encompass transitory propagating signals.

In various examples, the processor 702 couples to the non-transitory machine-readable medium 704. The non-transitory machine-readable medium 704 stores machine-readable instructions. The machine-readable instructions are the machine-readable instructions 706, 708, 710. The machine-readable instructions 706, 708, 710, when executed by the processor 702, cause the processor 702 to perform some or all of the actions attributed herein to the processor 702.

In various examples, when executed by the processor 702, the machine-readable instructions 706, 708, 710 cause the processor 702 to control transmissions of secure activities. The machine-readable instruction 706 causes the processor 702 to monitor for a transmission. The machine-readable instruction 708 causes the processor 702 to determine a type of the transmission. Responsive to a non-secure transmission, the machine-readable instruction 710 causes the processor 702 to switch to a first wireless transceiver (e.g., the wireless transceiver 304, 604, or the WLAN transceiver 432), and responsive to a secure transmission, the machine-readable instruction 710 causes the processor 702 to switch to a second wireless transceiver (e.g., the wireless transceiver 306, 606, or the cellular transceiver 434). In some examples, the first wireless transceiver is to facilitate communication via a wireless local area network (WLAN) and the second wireless transceiver is to facilitate communication via a cellular network.

In some examples, in response to a determination that the type of the transmission is indicative of a non-secure activity, the machine-readable instruction 710, when executed by a processor 702, causes the processor 702 to cause the first wireless transceiver to transmit data of the non-secure activity (e.g., the generic data 442), and in response to a determination that the type of the transmission is indicative of a secure activity, the machine-readable instruction 710, when executed by a processor 702, causes the processor 702 to cause the second wireless transceiver to transmit data of the secure activity (e.g., the confidential data 444).

In various examples, the processor 702 monitors the transmission for a keyword, a selection, or a combination to determine the type of the transmission. The processor 702 determines the type of the transmission based on the keyword, the selection, or a combination thereof. For example, responsive to a keyword that indicates a login process, the processor 702 determines the type of the transmission is a secure type of transmission. In another example, responsive to the selection that indicates a purchase process, the processor 702 determines the type of transmission is a secure type of transmission.

In some examples, in response to a determination that the type of the transmission is indicative of a non-secure activity, the machine-readable instruction 710, when executed by a processor 702, causes the processor 702 to cause the first wireless transceiver to switch on to transmit data of the non-secure activity, and in response to a determination that the type of the transmission is indicative of a secure activity, the machine-readable instruction 710, when executed by a processor 702, causes the processor 702 to cause the first wireless transceiver to switch off and the second wireless transceiver to transmit data of the secure activity.

In various examples, the method 100, 500 is implemented by machine-readable instructions stored to a storage device (e.g., the storage device 308, 608, the non-transitory machine-readable medium 704) of an electronic device (e.g., the client 202, the electronic device 300, 402, 600, 700). A processor (e.g., the processor 302, 602, 702) of the electronic device executes the machine-readable instructions to perform the method 100, 500, for example. A process, as used herein, refers to operations performed by execution of machine-readable instructions by the processor. A decision point, as used herein, refers to operations performed by execution of machine-readable instructions by the processor. Unless infeasible, some or all of the blocks (e.g., process, decision point) of the method 100, 500 may be performed concurrently or in different sequences. For example, the processor performs a block that occurs responsive to a command sequential to the block describing the command. In another example, the processor performs a block that depends upon a state of a component after the state of the component is enabled.

The above description is meant to be illustrative of the principles and various examples of the present description. Numerous variations and modifications become apparent to those skilled in the art once the above description is fully appreciated. It is intended that the following claims be interpreted to embrace all such variations and modifications.

In the figures, certain features and components disclosed herein are shown in exaggerated scale or in somewhat schematic form, and some details of certain elements are not be shown in the interest of clarity and conciseness. In some of the figures, in order to improve clarity and conciseness, a component or an aspect of a component is omitted.

In the above description and in the claims, the term “comprising” is used in an open-ended fashion, and thus should be interpreted to mean “including, but not limited to . . . .” Also, the term “couple” or “couples” is intended to be broad enough to encompass both direct and indirect connections. Thus, if a first device couples to a second device, that connection is through a direct connection or through an indirect connection via other devices, components, and connections. Additionally, the word “or” is used in an inclusive manner. For example, “A or B” means any of the following: “A” alone, “B” alone, or both “A” and “B.”

What is claimed is:

1. An electronic device, comprising:
a first wireless transceiver;
a second wireless transceiver; and
a processor to:
transmit data via the first wireless transceiver;
detect an indicator of a secure activity; and
in response to a detection of the indicator, stop transmission of the data via the first wireless transceiver and begin transmission of data of the secure activity via the second wireless transceiver.

2. The electronic device of claim 1, wherein the first wireless transceiver is to facilitate communication via a wireless local area network (WLAN), and the second wireless transceiver is to facilitate communication via a cellular network.

3. The electronic device of claim 1, wherein to detect the indicator of the secure activity, the processor is to monitor for a keyword, a selection, or a combination thereof.

4. The electronic device of claim 1, wherein the processor is to:
monitor for another indicator that indicates the secure activity is complete; and
responsive to a detection of the another indicator, stop transmissions via the second wireless transceiver and continue transmissions via the first wireless transceiver.

5. The electronic device of claim 1, wherein the data of the secure activity is confidential data.

6. An electronic device, comprising:
a first type of wireless transceiver;
a second type of wireless transceiver; and
a processor to:
detect an indicator of a secure activity, the indicator received via the first type of wireless transceiver; and
in response to a detection of the indicator, cause transmission of data of the secure activity via the second type of wireless transceiver.

7. The electronic device of claim 6, wherein the first type of wireless transceiver is to facilitate communication via a Wi-Fi network and the second type of wireless transceiver is to facilitate communication via a cellular network.

8. The electronic device of claim 6, wherein in response to the detection of the indicator, the processor is to cause the first type of wireless transceiver to switch off.

9. The electronic device of claim 6, wherein the processor is to:
monitor for another indicator that indicates the secure activity is complete; and
responsive to a detection of the another indicator, cause transmission of data of a non-secure activity via the second type of wireless transceiver.

10. The electronic device of claim 9, wherein in response to the detection of the another indicator, the processor is to cause the first type of wireless transceiver to switch on.

11. A non-transitory machine-readable medium storing machine-readable instructions which, when executed by a processor, cause the processor to:
monitor for a transmission;
in response to a detection of the transmission, determine a type of the transmission;
in response to a determination that the type of the transmission is indicative of a non-secure activity, cause a first wireless transceiver to transmit data of the non-secure activity; and
in response to a determination that the type of the transmission is indicative of a secure activity, cause a second wireless transceiver to transmit data of the secure activity.

12. The non-transitory machine-readable medium of claim 11, wherein the processor is to monitor the transmission for a keyword, a selection, or a combination thereof to determine the type of the transmission.

13. The non-transitory machine-readable medium of claim 11, wherein the first wireless transceiver is to facilitate communication via a wireless local area network (WLAN) and the second wireless transceiver is to facilitate communication via a cellular network.

14. The non-transitory machine-readable medium of claim 11, wherein in response to the determination that the type of the transmission is indicative of the non-secure activity, the processor is to cause the first wireless transceiver to switch on to transmit data of the non-secure activity.

15. The non-transitory machine-readable medium of claim 11, wherein in response to the determination that the type of the transmission is indicative of the secure activity, the processor is to cause the first wireless transceiver to switch off.
